(19) United States
(12) Patent Application Publication
(10) Pub. No.: US 2005/0198773 A1
(43) Pub. Date: Sep. 15, 2005

(54) Magnetism to control compressive friction checks for rods including those of door closers

(76) Inventor: Ricardo Alonso, Denver, CO (US)

Correspondence Address: Ricardo Alonso, 111 S. Perry St., Denver, CO, 80219, US

(21) Appl. No.: 10/797,396

(22) Filed: Mar. 9, 2004

(51) Int. Cl. E05F 3/00

(52) U.S. Cl. 16/49

(57) ABSTRACT

A magnet (72) for triggering a compressive friction check (22) to disengage (22A) and engage (22B) certain rods (16), such as those for door closers (10) which are utilized for controlling linear biasing forces (11A) and (11B) for objects such as doors (62). Such devices (10) normally provide a rod (16) from within a body (12), disposing a biasing means (11) compliant to the object (62). The check tab (22) normally comprises an aperture (26) opposing compressive friction points (28) for applying to the tensile rod (16), which are contained within a structure (34) attached to a trigger (38) for levering the check (22) onto the extended rod (16B). The magnet (72) optionally cause the check (22) to operate the basic, immediate, progressive, and limited tab set options, thus creating a true feather touch check (22) for door closers (10). Furthermore, the magnet (72) creates an operator (10) for residential doors (62) that may utilize a low-voltage rechargeable battery (86), and lends to numerous other devices (10) including a sliding door operator (10).

### TECHNICAL FIELD

This invention relates to various reciprocating devices that control certain and objects with linear biasing forces. Exemplified is a door closer that acts to return the door to a closed position. The device normally comprises a rod that reciprocates from within a body providing a biasing means to the forces. For holding the door in an opened position, the rod can be loosely mounted with a frictional check mechanism. Also known as a hold-open tab, it mounts onto the rod through an aperture. When triggered, the tab frictionally engages the extended rod with compressive opposing points comprised within the aperture.

More particularly, this invention relates to the use of a magnetic means to trigger checks for engagement and release, such as for holding the door opened and then permitting closure. The numerous inventions disclosed herein might not be possible without including Alonso's other inventions to improve reciprocating devices, as described in U.S. Pat. Nos. D395,995; D425,776; D425,399; 5,953,789; 6,032,331; 6,397,431; 6,640,387 all to Alonso. A portion of this disclosure contains material which is subject to copyright protection. There is no obligation to its reproduction in the US PTO, however all copyrights are reserved.

### BACKGROUND ART

Check mechanisms are normally metal stamped from a sheet steel and comprise two relevant components to the invention herein: the aperture and the trigger. The reader is encouraged to study a complete disclosure concerning various checks in U.S. Pat. No. 5,953,789.

The hold feature is activated by first opening the door to a desired position which also extends the rod. A counter-force is then created as a result of the biasing means within the body. To hold, the check is axially positioned onto the extended rod through the aperture. Releasing the door, the biasing means acts to return the extended rod for closure. Once the body contacts the trigger, the biasing force causes the check to lever and torsionally pivot on the lineal axis of the rod.

The check frictionally engages the extended rod with compressive opposing points within the aperture. The force is equalized and distributed by the points within an axial plane, interacting to deliver the compressive frictional pressure onto the rod. Thus, the compressive frictional pressure created by the points causes the check to engage the rod and hold the door. More torsion applied to the trigger normally results in more compressive frictional pressure onto the tensile surface of the rod.

Other than the inventor's check, all others utilize only two compressive friction points offered within the aperture. These two points are distantly opposed at no less than the rod diameter. Most two point checks are initially sufficient to hold the door opened, however the points eventually wear causing slippage on the rod and unintentional closure. Fatiguing points lack stability onto the smooth cylindrical surface of the rod, which causes the check to rotate laterally as more torsion is applied onto the trigger. This lateral rotation further inhibits the compressive friction, which ultimately causes the check to slip and fail.

Comparatively, the inventor's check comprises an aperture that applies more than two compressive opposing points. The distance between the points is less than the rod diameter, applying more friction and balances the check to overcome lateral instability. The structure which houses the aperture is offset, separating the points over a larger tensile area. As the points wear they actually become stronger by distributing more compressive friction. The offset permits a vertical posture for the check which provides a continual engagement onto the rod. That is, the check keeps itself engaged by its own weight with no further pressure required. The offset also allows the check to substantially rotate in reversal up to 45°, to allow it free-slide similar to a guide or bearing when not needed.

A variable trigger plane is defined in U.S. Pat. No. 6,032,331. The trigger comprises a continual curvature surface which increases the leverage for the compressive points, and, coincidentally decreases the applicable torsion required to engage the check. However, the more torsion that is applied to the trigger results in more compressive frictional pressure applied onto the rod.

Combining the above inventions creates a phenomenally strong and reliable check that should never slip or wear, as tested to over 300 lbs of direct linear force continually applied to a present check. The amount of compressive frictional pressure that can be applied by the points is only limited by the tensile strength of the rod. Not even a coal of lubricant seems to affect the check once it engages. The inventor believes that these components mostly render all of the inventions herein as well as others soon to be disclosed.

There are several known options for engaging and releasing check mechanisms, individually all presenting virtues and tribulations:

The first shall be referenced as Basic Tab Set, the most reliable way to hold a door opened. The tab must be manually placed onto the extended rod by the user who must first open the door then slide the tab from idle. The tab's trigger contacts the closer body and torsionally causes the check to lever. However, in order to close the door the tab must again be returned back to idle. This basic option poses inconvenience particularly for children, and disabled people using mobility devices whom may not be able to easily move the tab. Fingers are often pinched by the trigger, especially when attempting to set a fatigued check.

The second option shall be reference as Immediate Tab Set, partially deriving from the inconveniences described above. A recent door closer comprises a pushbutton to engage the check for holding the door. Once the button is pushed, a lever causes the tab to immediately engage and hold the door opened. The most desirable feature about this device is that the user needs only push the door further outward to cancel the check for closure. A spring within the body cancels the tab once the torsion to the trigger is relieved. However, the check tab may be compromised by premature closure from incidental bumping to the door. This becomes apparent when moving large objects through the doorway such as furniture, and especially for users of mobility devices such as wheelchairs and walkers.

The third option shall be referenced as Progressive Tab Set, available for holding the door at every outward position. Some devices use a dial adjacent to the tab which is rotated for engagement. The most desirable feature about this device is that it omits premature closure, by the continuing hold as the door is pushed outward. However, in order to close the dial must again be rotated which may too create difficulties for certain users.

The fourth option shall be referenced as Limited Tab Set, requiring that the door be opened to approx. 90° in order to engage the tab. Similar to the pushbutton device, to close the user need only bump the door slightly outward to cancel the tab. However, most users may not always desire that their door be fully opened just for setting the check. Some manufactures for these devices are now including a separate manual tab for checking the door at less than the full open position.

It becomes apparent that a single closer device should be created to encompass many of these check options, wherein each may become circumstantially available and disposable.

### DISCLOSURE OF THE INVENTION

These inventions relate to the use of a magnetic means to trigger check mechanisms for reciprocating devices, thus creating the first known door closer capable of most the check options described above. Objects of these inventions are to create a check tab capable of basic set, immediate set, and progressive set. Other objects of these inventions are to create reliable power for controlling the check, versus other mechanisms such as springs or levers.

A primary magnet can be easily manufactured into to the closer and into the check. However, for immediate adaptation onto certain closers the magnet can be housed within a simplistic plastic cup to easily retrofit without any modification to the device. Objects of these inventions are to utilize components having no fasteners, no moving parts, and minimal cost. The cup or end cap may further comprise surfaces that control the various check options. Objects of these inventions are to create versatility for the check and the device.

By locating the primary magnet horizontally, the tab is drawn sideways to freely travel on the rod as the door opens and closes. When needed, the tab becomes convenient for immediate set similar to the pushbutton device. However, the force required to set the magnetic check is no more than the touch of a feather. This ease of operation promptly disposes the tab at every position including full open set. To close the door the user need only bump it slightly outward and the magnet then disengages the tab.

If the user requires that the door be held reliably such as for moving furniture, the manual tab option is available by simply twisting the tab to its normal vertical position. The unique shape of the tab's trigger does not allow pinched fingers. For disabled users, a second temporary magnet comprising minimal moving parts will progressively hold the door at every outward position. Utilizing a damper as defined in U.S. Pat. No. 6,397,431 that could open the door, an inexpensive low-voltage operator could be created for residential entry doors. Such a device will perform as a reliable closer only, until remotely activated to power the door.

Furthermore, the inventor has anticipated his superior check expounding into numerous other industries that utilize rods for controlling objects with linear biasing forces. The inventor has best exemplified such a device as the common door closer, merely comprising a rod to the object and biasing force operators from within a body. Although other devices may not appear as the simplistic closer, the predictable function of the rod similarly provides the inherent need to control the object, even from the forces of gravity.

From U.S. Pat. No. 5,953,789: “The inventive check (emphasis) mechanism may incorporate a second trigger. The object of this invention is to change the direction of the friction pressure torsionally applied onto the surface of the rod, thus creating a reversible mechanism Another object of this invention is to accommodate the various reciprocating devices.”

During testing of the magnet, the inventor linked two checks by mating each at their trigger. The results created a phenomenally strong compressive friction check, capable of bidirectional control to a rod utilizing its tinsel strength. This new linking invention may be comparable to the ancient art of friction to flexible rods, often known as a “Chinese Finger Cuff”. However, the inventor may have solely developed a comparable apparatus and methodology only now capable to firm rods for any useful purpose.

Likewise, engaging and releasing the check offers basic, immediate, progressive, and limited tab set options for many devices. These might include a sliding door operator; buckles; pulling, towing, and hitching devices; linear actuator and robotic controllers; extension polls; clamps; adjustable freestanding pedestals; triggers for launching rods such as arrows; tent, canopy, and banner clips; threadless fasteners; adjustable tools such as wrenches and pliers; an improved caulking gun and many others.

Objects of these combined inventions are to capture the entire usable tinsel strength of a rod, for controlling any object attached thereto. Other objects of these inventions are to induce reliable compressive frictional pressure to a rod, for holding linear biasing forces no matter what the origin of the force. Please note that this linking invention requires a separate patent perhaps neither divisional nor dependable on the magnetic invention herein. However, the magnetic invention unites the link to improve many reciprocating devices and therefore mandates the disclosure herein.

### DESCRIPTION OF THE DRAWINGS

FIG. 1 is a prospective view of the invention, a magnetic means to control check mechanisms for reciprocating devices including door closers.

FIG. 2 shows the magnet positioned for immediate adaptation onto a door closer device.

FIG. 3 foremost shows a superior check mechanism the check also shown vertically mounted onto the closer in both the idle and engaged positions.

FIG. 4 shows the check detained horizontally by the magnet, now immediately available for setting by the user with no more force than the touch of a feather held within the hand.

FIG. 5 shows an exposed side of view of the door closer adapted with the magnetic invention.

FIG. 6 shows another magnetic invention comprising a temporary wheel for progressively controlling the tab.

FIG. 7 shows the door closer now mounted with the progressive magnet in the off position.

FIG. 8 shows the progressive magnet in the on position.

FIG. 9 shows a reciprocating device and check mounted with the invention, and a low-voltage operator capable of converting a normal door closer into an inexpensive door opener.

FIG. 10 shows a door in the closed position with the device of FIG. 9.

FIG. 11A shows a remote signal which may command the invention to open the door.

FIG. 11B shows the advancing magnetic invention preparing the device to open the door.

FIG. 12 shows the door with the device of FIG. 1B.

FIG. 13 shows the device returning to a normal position and assisting to open the door.

FIG. 14 shows the door operated by the device of FIG. 13.

FIG. 15 shows the elementary creation of the magnetic invention with a link invention, for checks to control all linear biasing forces of any rod, regardless of the origin for the forces.

FIG. 16 shows the elementary creation of the applied magnet and link to other bi-checks.

FIG. 17 shows a side view of dual magnetized and linked bi-checks, first illustrated on a rod disengaged by reversed polarity, then engaged by normal polarity.

FIG. 18 shows the magnetic invention applied to a bi-check mechanism comprising dual apertures and triggers, perhaps for controlling linear biasing forces of dual rods.

FIG. 19 shows two bi-checks of FIG. 18 combined to control linear biasing forces of dual rods for any useful purpose.

FIG. 20 shows the magnetic invention applied to a bi-check comprising dual triggers, for controlling all linear biasing forces of many rods.

FIG. 21 shows a side view of two magnetized and linked bi-checks from FIG. 20, illustrated on a rod in both the disengaged and engaged positions.

FIG. 22 shows an exposed side view of three bi-checks similar to FIG. 21.

FIG. 23 shows an exposed side view of three bi-checks similar to FIG. 22, however aligned directionally and only shown in the disengaged position.

FIG. 24 shows a reciprocating device mounted with a magnetized and linked bi-check similar to either FIG. 22 or FIG. 23.

FIG. 25 shows a side view of five disengaged bi-checks similar to FIG. 22, only now comprised within a case for any useful purpose.

FIG. 26 shows an exposed side view of FIG. 25 now engaged.

FIG. 27 shows a side view of five bi-checks similar to FIG. 25.

FIG. 28 shows an exposed side view of FIG. 27 now engaged.

FIG. 29 is reserved to show an applicable view of a similar magnetized and linked bi-check.

FIG. 30 shows a prospective view of a finished case bi-check both as disengaged 22A then engaged 22B, comparable to FIGS. 25-26 for usage on the sliding door of FIGS. 31-32.

FIG. 31 shows a sliding door mounted with a reciprocating device, and the disengaged check of FIG. 30.

FIG. 32 shows the sliding door and the engaged check of FIG. 30.

FIG. 33 shows a reference list.

### BEST MODES FOR CARRYING OUT THE INVENTION

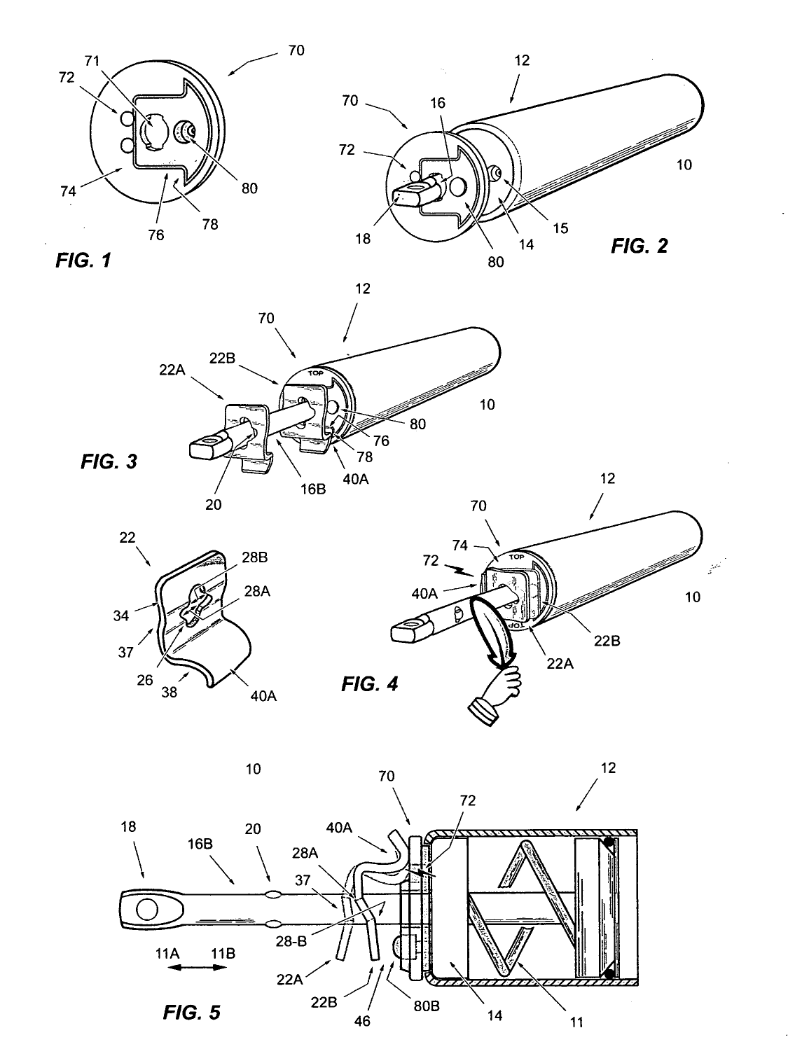

FIGS. 1-5 are taught together showing the invention, a magnetic means 72 to control superior checks 22 for reciprocating devices 10. The magnet 72 may be housed within a plastic cup 70, perhaps containing twin primary magnets 72. For best performance, a landing 74 will permit the check 22 smooth rotations onto the convex surface 40A of the trigger 38. A check lock 76 secures the trigger 38 in both the horizontal and vertical if you positions. A check stop 78 is for positioning the engaged check 22B vertically when using the basic tab set. An option report 80 is provided for various reasons describe below. It is important that the reader understand that the exclusive invention herein consist of the primary magnet 72, wherein the cup 70 merely provides expediency for the invention.

The best magnet 72 seems to be Neodymium Iron Boron (NdFeB). According to the industry they are the most powerful “rare earth” magnets known to mankind which are capable of providing 4-5 times more power than ceramic magnets. They are also very hard which creates a durable plane for the convex surface 40A. The only thing that can weaken NdFeB magnets are temperatures of over 250° F.

FIG. 2 shows the retrofit installation procedure for the cup 70 onto the closer device 10, through the aperture 71 onto the rod 16. It is strongly suggested that the magnetic invention 72 be fitted to the end cap 14 at manufacturing for the device 10. Please note that when retrofitting the magnet 72 onto a closer 10, the user must position the cup 70 to clear the rod hub 18 and lugs 20. No fasteners are required as the magnet 72 attaches to the end cap 14. However, an option port 80 is provided for a rivet fastener 80A to communicate with an end cap port 15, perhaps desired when retrofitting the magnet 72 to the device 10. The cup 70 and magnet 72 may be used for left or right doors 62 by simple orientation.

FIG. 3 shows a superior check 22 housing an aperture 26 which opposes friction points 28 defined as the fulcrum 28A and the counter 28B. The aperture 26 is created within a structure 34 comprising offset planes 37, all components attached to a trigger 38 utilizing an arched, ovoid or convex surface 40A. The device 10 shows the check 22 mounted vertically for basic tab set, as it is typically moved by the user from idle 22A to engage 22B. Note the check lock 76 and check stop 78 maintain the trigger convex 40A, to prevent unintentional attraction for the check 22B towards the magnet 72 while in the basic tab set.

FIG. 4 shows the check 22 supported horizontally by the magnet 72 (hidden), now positioned for immediate tab set. To engage 22B, the user need only touch the check 22 with light force as demonstrated. To disengage 22A, the door 62 (not shown) needs to be bumped slightly outward and the magnet 72 will draw the trigger 40A to release the rod 16. Note that the user can apply slight inward force to the door 62 for securing the engaged tab 22B more firmly onto the rod 16. This will help prevent the door 62 from accidental closure due to an unintentional light bump. Certainly the user can choose basic tab set by simply again rotating the engaged check 22B to vertical.

FIG. 5 shows the unique ease of operation, installation, and lack of moving parts for the magnetic invention 72 contained within cup 70. The opt port 80 may comprise a button 80B to possibly cancel the check 22A by closing the functional gap 46, as when the user forcefully attempts to close the door 62 while its held by the engaged check 22B. Perhaps these inventions may permit the magnet 72 certain movement by the biasing means 11 and end cap 14. This concept could eliminate the cup 70 entirely, or at least require a smaller diameter to better inset within the body 12.

Note that the points 28 comprised within the structure 34 have offsetting planes 37, which allow the check 22 to substantially rotate on the extended rod 16B. This rotation is limited only by the lock 76 contacting the convex trigger 40A. Thus, when not in use the points 28 act as bearings or guides permitting the unusually smooth motion for the check 22 from engaged 22B to idle 22A and back to engaged 22B. Please note that the magnet 72 might function with certain other prior two point checks 22, perhaps by utilizing other components such as springs or levers. Certainly such a mechanism could be inferior to the inventor's superior check 22, although please consider this disclosure herein.

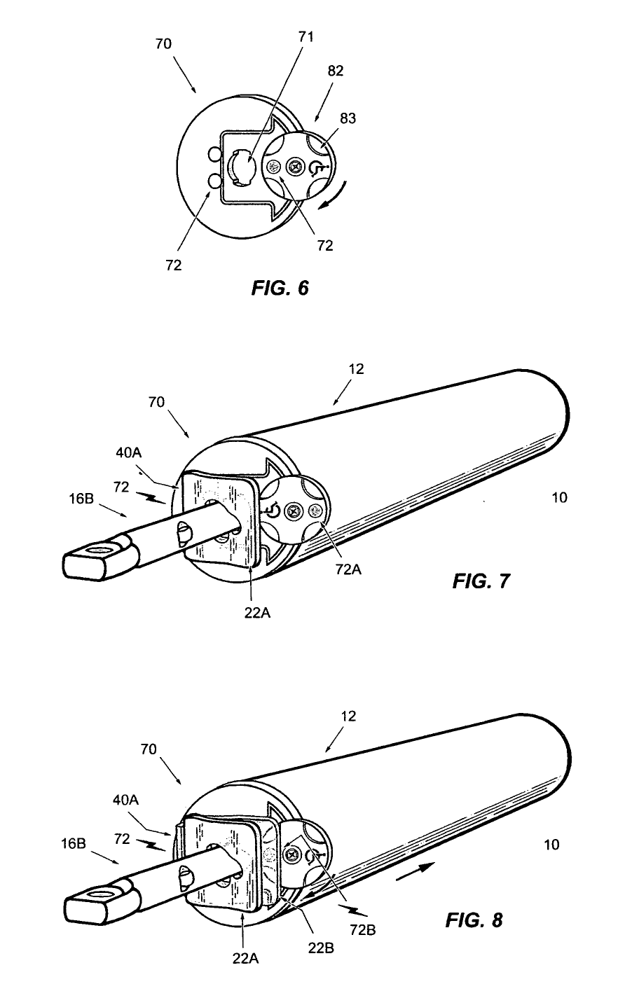

FIGS. 6-8 are taught together showing another magnetic invention 72 provided within a wheel 82, for progressively holding the engaged check tab 22B that every outward position. This feature may be most practical for users of mobility devices, whom are exiting a screen door 62 (not shown). For this purpose, the idle tab 22A is held horizontally by the original primary magnets 72. In preparation, the wheel 82 is rotated 180° using a finger to the notches 83 which magnetically 72B draws the structure 34 to engaged the tab 22B. As the door 62A is pushed outward 62B, the combined magnets 72 progressively hold the check 22 to accommodate the mobility device.

Once outside, the user can cancel the check tab 22A by again rotating the wheel 82 then bumping the door 62 for closure. However, if the device 10 provides a damper 50 (not shown) as in U.S. Pat. No. 6,640,387, the door 62 can be closed while the extended rod 16B is held by the tab 22. This will assist to open the door 62 upon return trip, wherein the user can then rotate the wheel 82 and bump the door 62 for closure. By placing magnets 72 (not shown) behind the wheel 82 at each 180° interval, a “click” stop is created for the on/off positions.

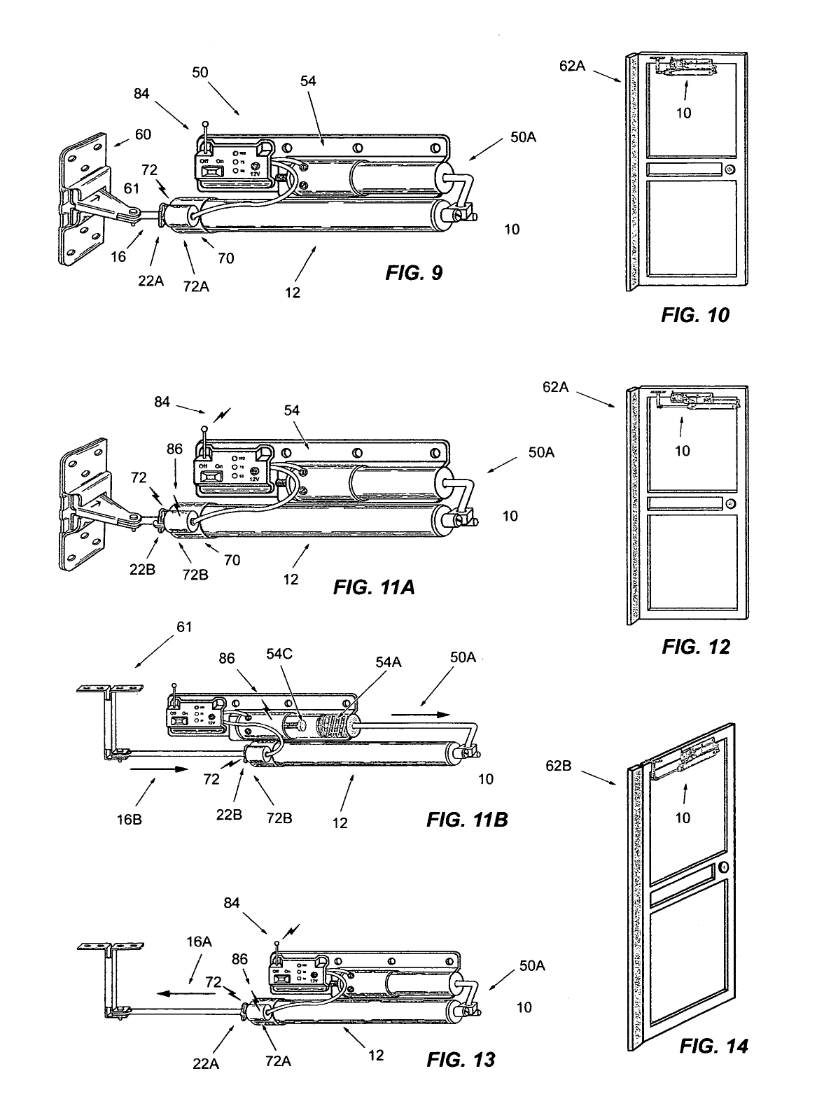

FIGS. 9-14 are taught together showing a closer device 10 with the magnet 72 comprised within the cup 70. A damper 50 as defined in U.S. Pat. No. 6,640,387, provides a bracket 50A attaching to the device 10. The damper 50 permits the device 10 to normally act as a closer only, until remotely activated 84 to engage a lineal actuator 54. Note the magnet 72 maintains the idle check 22A horizontally, however at any time permits the user to opt for basic tab. FIG. 10 shows a closed door 62A and device 10 under normal operation.

FIG. 11A shows the remote activator 84 setting in motion a power supply 86 for a solenoid or small motor, to engage the check 22B with a magnetic means 72B. This prepares the device 10 and the engaged check 22B for progressive tab set similar to FIG. 8. Such a power supply 86 might comprise a rechargeable 12-24V DC battery, which may be capable of operating for many months between charges. Please note that several type doorjamb brackets 61 are shown.

FIG. 11B shows the remote activator 84 setting in motion a power supply 86 to the lineal actuator 54, to advance the drive 54C and extend the damper spring 54A and bracket 50A Note that the drive 54C only requires approx. 6 inches of extension to fully open an average door 62B, and is shown after advancing the spring 54A and bracket 50A. The operator 54 does not require power to open and hold the door 62B, as the extended rod 16B, and the extended bracket 50A, and the energy of the damper spring 54A are all held by the engaged check 22B only. The low-voltage operator 54 can energize for activation while remaining in the closed door position 62A, as shown in FIG. 12.

FIGS. 13-14 show that the bracket 50A has caused the opened door 62B by the engaged check 22B. After a timed interval, the remote activator 84 can again set in motion the power supply 86 to the solenoid, which disengages the check tab 22A to retract the rod 16A and cause the closed door 62A FIG. 14 clearly shows that the combined inventions have caused the opened door 62B, and, note that the device 10 appears to be under normal operation as though not equipped with any additional components. Please note that if the remote 84 is inadvertently activated while in the opened door 62B, the advancing bracket 50A will only cause the door again towards the closed 62A which can overcome possible damage to the device 10.

Note that U.S. Pat. No. 5,592,780 describes an invention that utilizes an electromagnetic means (43) for controlling the check (26), however must not be construed as being anticipated by the inventive concepts described herein. The check (28) comprises only two friction points (29A) applied to the rod (29). Because the lack of points (29A) combined with a non-variable trigger plate (28A), the check (28) must be controlled by the latch plate (26) in order to utilize the magnetic head (43). Furthermore, the latch (26) must be pinned to the flex plate (65) which is further secured by a backing plate (61), with all the above references housed a within a mounting container (51). Comparatively, the invention herein primarily requires a magnet to similarly control the check.

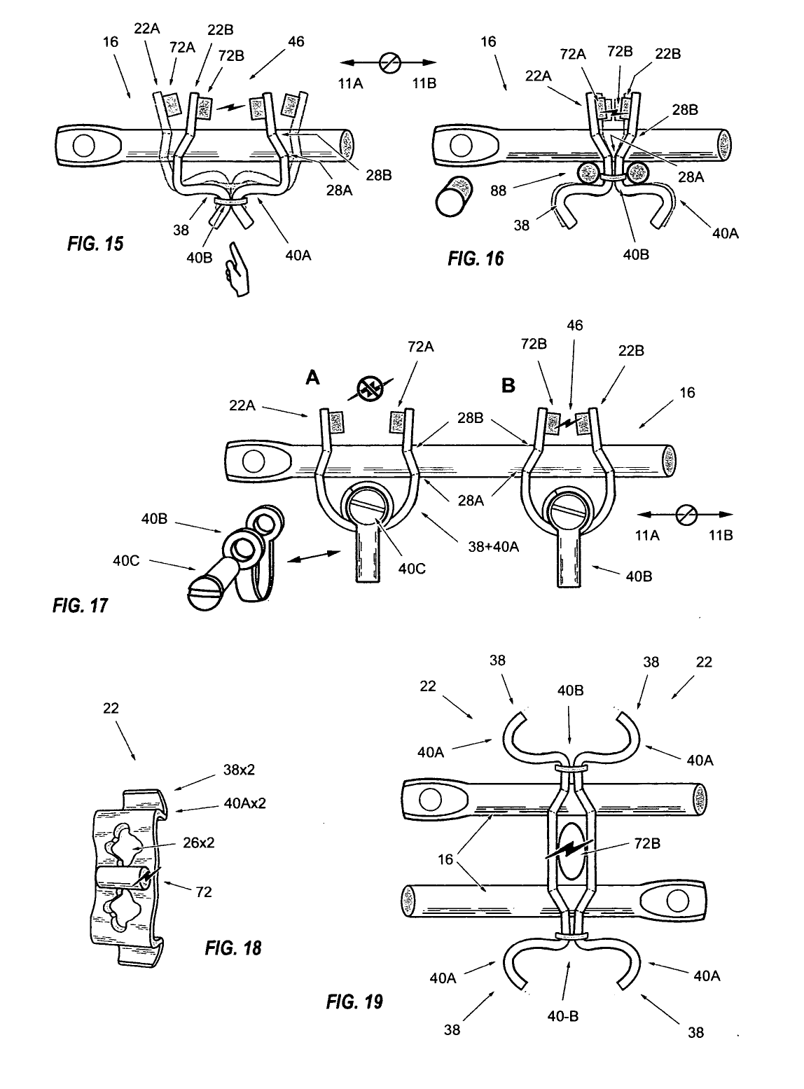

FIGS. 15-32 derive from U.S. Pat. No. 5,953,789: “Reverseability to the mechanism 22 may result from plural trigger appendages 38, as both the outward force 11A and inward force 11B may be checked.” The reader is urged to learn variable triggers taught in U.S. Pat. No. 6,032,331.

FIGS. 15-17 are taught together wherein all show the inventor's elementary testing of a check 22 adapted with the magnetic invention 72, and adapted to a new link invention 90 which creates multiple checks 22 for simultaneously disengage 22A and engage 22B certain rods 16 to control objects 62 for any useful purpose. Please note that the inventor has only tested his magnet 72 and link 90 inventions to bi-checks 22 mounted on rods 16 similar to those from door closer 10. Such are usually composed of relatively mild steel. Not yet known about any appropriate rod 16 is the tensile strength, compressive strength, sheer strength, fatigue strength, elasticity, plasticity, malleability, toughness, or hardness.

The bi-checks 22 are linked 90 at their triggers 38, permitting smooth rotation on the convex surfaces 40A for disengaging 22A and engaging 22B. The engaged checks 22B are held by the engaged magnets 72B. To disengage 22A, a simple hand movement to the bi-check 22 will suffice to disengage the magnets 72A similar to the basic tab set option. Note that the function gap 46 is required at all times during engaged check 22B. A lock means 88 will properly secure the engaged checks 22B.

FIG. 17 shows two useful options for the magnetized 72 and linked 90 bi-checks 22 mounted onto a rod 16. The triggers 38 comprise an arching surface 40A, and a clip 40B is demonstrated perhaps useful for suspended objects 62 (not shown). Option A shows a normally disengaged bi-check 22A by reversed polarity causing disengaged magnets 72A. Theoretically, pressure applied to the clip 90 such as the weight of a suspended object 62 could cause engagement 22B, while removal of the object 62 could again cause release 22A. Option B shows a normally engaged bi-check 22B by correctly opposed magnets 72B.

FIG. 18-19 shows a bi-check 22 magnetized 72 and linked 90, offering dual apertures 26 and dual triggers 38 for controlling all linear biasing forces 11A and 11B of dual rods 16. Useful purposes might include linear and robotic controllers 10 (not shown). Theoretically, as the opposed triggers 38 are compressed, the near rod 16 may surrender movement from its biasing force 11A or 11B, permitting movement for the other rod 16.

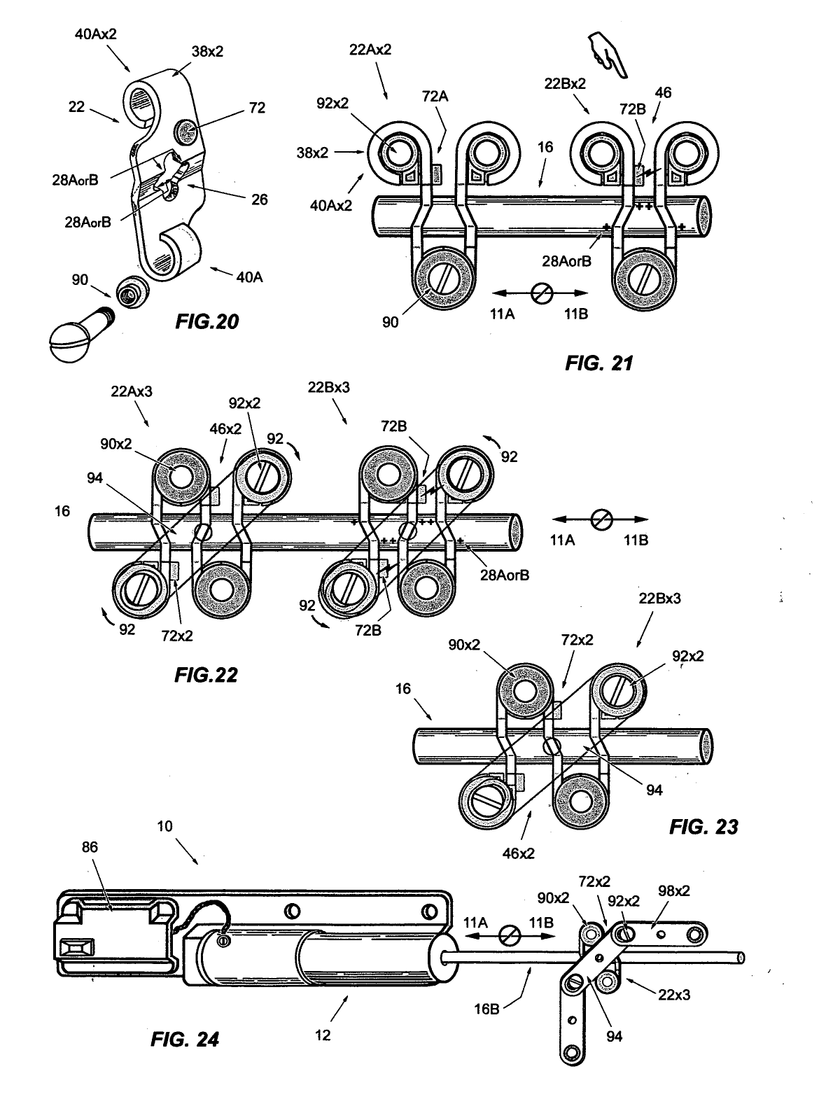

FIGS. 20-24 are taught together wherein FIG. 20 shows the magnetic invention 72 applied to a bi-check 22 for controlling all linear biasing forces 11A and 11B of any rod 16. The friction points 28 perform as either fulcrum 28A or counter 28B, depending on the direction of the force 11A or 11B. There are at least two triggers 38, each with variable surfaces including a convex surface 40A. Each trigger 38 can opt to mate with another bi-check 22 by means of a link pin 90. Only a single configuration is required to create unlimited linkable bi-checks 22 for any purpose.

FIG. 21 shows a side view of two combined bi-checks 22 from FIG. 20 for controlling both forces 11A and 11B, now onto a rod 16 in both idle 22A then engaged 22B, and poised for basic tab set. At least one trigger 38 forms a link 90 to create a singular bi-check 22. Because the idle bi-check 22A is cable of immediate tab set, very little torsion is required at the load bearings 92 for securing both force 11A and 11B by the multiple compressive friction points 28. The magnet 72 sufficiently maintains a pressure required to keep the engagement 22B. The functional gap 46 requires that the each check 22 does not touch. To disengage 22A, the function gap 46 requires only a slight separation. Please note that the magnet 72 for bi-checks may be expendable by other mechanisms such as springs or levers.

FIG. 22 shows an exposed side view of three linked bi-checks 22 for controlling both forces 11A and 11B of the rod 16, illustrated as both idle 22A then engaged 22B. Linking 90 is similar to FIG. 21 however a cross-link 94 now binds both load bearings 98 for simultaneous operation. Note the difference between idle 22A and engaged 22B appears slight, apparent by the change to the cross-link 94 at the bottom-most load bearing 92. Also note the offsetting planes 34 will permit the nesting of other “bi-checks” 22 by flipping each paired checks 22 to others 22.

During check engagement 22B, control for the biasing forces 11A and 11B appears to be unconditional, only limited by the tensile strength of the rod 16 versus the number of applicable friction points 28. In other words, the union created by the compressive friction points 28 applied to the rod 16 appears to be only dependent on the tensile strength of the rod 16. Similar to the “Chinese Finger Cuff” concept, this new invention may provide reliable compressive frictional restraint onto any rod 16, perhaps along its entire tinsel length!

FIG. 23 shows an exposed side view of three disengaged bi-checks 22B similar to FIG. 22, however they appear to be directionally orientated in a one-way pattern. Perhaps this bi-check 22 could permit more linear control to release 22A and engaged 22B the rod 16 and object 62 (not shown), with similar results to the progressive tab set option. Applicable devices 10 might include extension polls 10, buckles 10, and freestanding pedestals 10.

FIG. 24 shows a reciprocating device 10 mounted with a magnetized 72 and linked 90 bi-check 22 similar to either FIGS. 22-23. The device 10 may be comparable to linear actuator 10. Note that the load bearings 92 are further supported by a tie link 98, perhaps useful for robotic controllers 10 (not shown) to act as switches as with the limited tab set option.

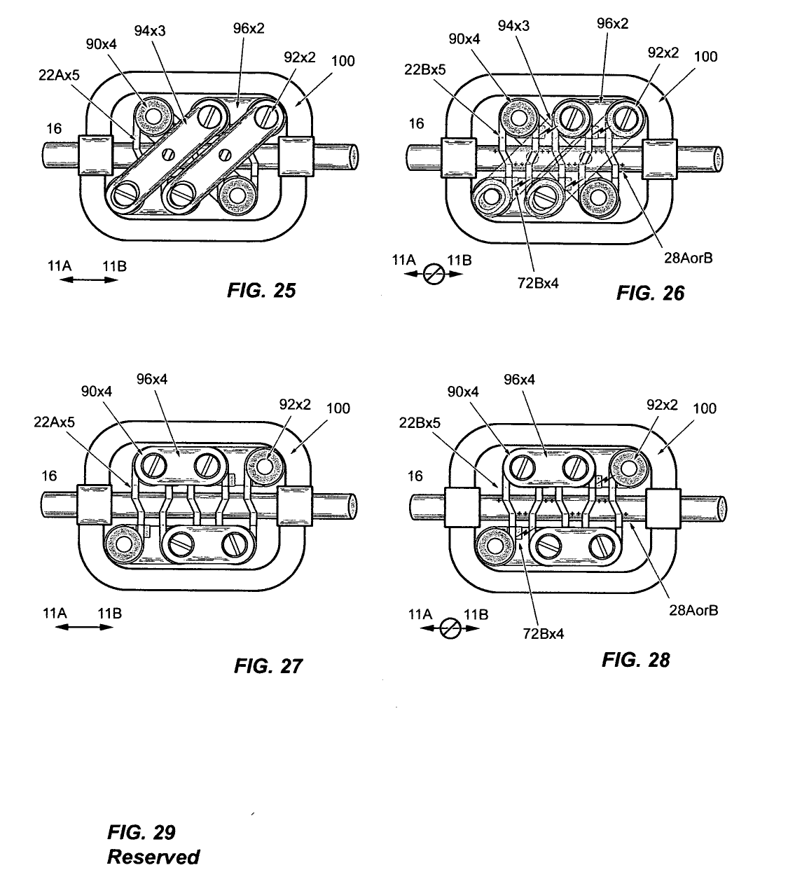

FIGS. 25-28 are taught together wherein FIG. 25 shows a side view of five disengaged bi-checks 22A similar to FIG. 22 only now comprised within a case 100, perhaps acting as a protector for the bi-checks 22. Note the load bearings 92 are utilizing the case 100 as a theoretical damper system. Also note that a direct link 96 binds to the load bearings 92 to the cross-links 94.

FIG. 26 shows an exposed side view of FIG. 25 only now engaged 22B. Note the multiple compressive friction points 28 consume the rod 16, limited only by its size and length. Such a bi-check 22 might be utilized for extreme pressures, perhaps to both the link bearings 90 and the load bearings 92. Applicable devices 10 might include lifting, towing, and hitching devices 10 perhaps capable of moving the weight of a train 10.

FIGS. 27-28 similarly show a side view of five bi-checks 22, however a omitting the cross-links 94. This check 22 systematically also appears to be capable of withstanding maximum forces 11A and 11B applied to any rod 16 for any useful purpose. FIG. 29 is reserved to show a similar magnetized 72 and linked 90 bi-checks 22.

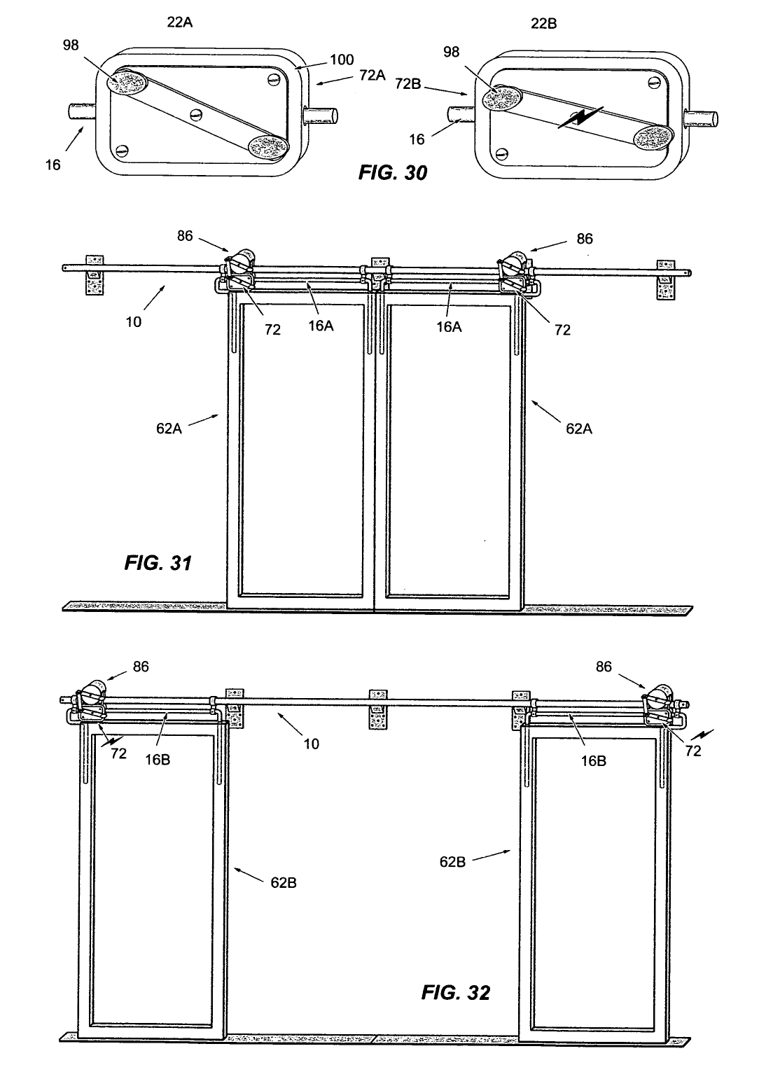

FIG. 30 shows a prospective view of a disengaged bi-check 22A, then engaged 22B, both shown a finished case 100. Please comparable these to FIGS. 25-26 or FIGS. 27-28, perhaps useful for the sliding doors of FIGS. 31-32. Note the slight movement to the tie link 98 between the two positions 22A-22B, activated and controlled the power supply 86.

FIG. 31 shows the closed sliding doors 62A mounted with reciprocating devices 10, and the disengaged bi-checks 22A of FIG. 30. FIG. 32 shows the opened sliding doors 62B resulting from the engaged checks 22B. Note that an important benefit for such a device 10 is that it only in slaves a door 62 during check engagement 22B. Otherwise, the door 62 is permitted to slide or swing freely, perhaps useful for emergencies including fire escape.

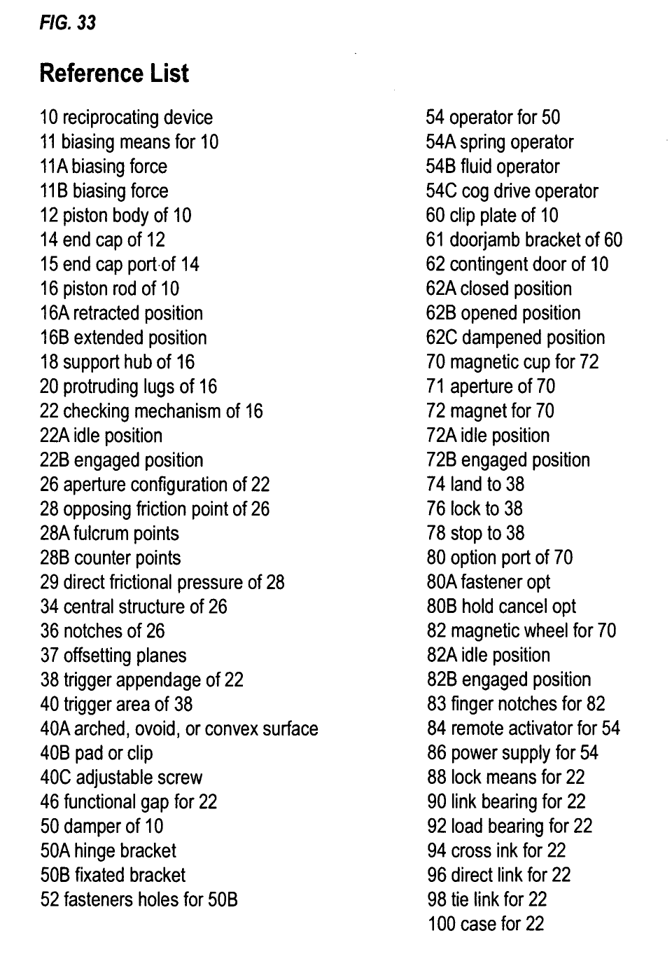

FIG. 33 shows a reference list.

### INDUSTRIAL APPLICABILITY

The present invention comprises the use of magnetism adapted for triggering check mechanisms to engage and release from biasing rods. No other closer has ever offered both basic and immediate tab set options derived from a single check. It is also important that the reader understand that only these inventions create this first known feather touch check for door closers.

By adding a simple magnetic wheel, a closer is also now capable of providing basic, immediate, and progressive tab set. The combined inventions also create the first door operator comprising an inexpensive low-voltage rechargeable battery, perhaps for residential industries. Such a device would act as a reliable closer only, until remotely energize with timed intervals to assist by opening & closing the door.

Furthermore, the reader will soon learn a separate disclosure which combines the magnetic invention to a linking invention, for compressive friction check mechanisms adapted to rods and objects attached thereto. Extraordinarily, this invention may be similar as the ancient art of compressive frictional engagement to flexible rods known as a “Chinese Finger Cuff”. Such may be utilized by many industries to reliably control all the biasing forces by utilizing the entire tinsel strength of the rod.

These combined inventions will create many industrial devices including buckles; pulling, towing, lifting, and hitching devices; sliding door operators; linear actuator & robotic controllers; clamping devices; extension pole devices; standalone pedestal devices; trigger devices; tent & canopy devices; adjustable tools such as wrenches and pliers, improve caulking gun and many others.

The particular embodiments of the present invention which have been illustrated and discussed herein are for demonstrative purposes only, and are not considered limited upon the scope of the appended claims. In these claims set forth it is my intent to all the inventions discovered, except as I am limited by the prior art. From this disclosure, various changes or improvements may occur wherein any applicable claims are intended to be included therein.

1. A cup (70) for causing a compressive friction check mechanism (22) to engage (22B) and disengage (22A), utilized to hold the linear biasing forces (11A) and (11B) of a reciprocating device (10) and any object (62) attached thereto, exemplified as a door closer (10) comprising at least one rod (16) which linearly reciprocates from within a body (12) housing a biasing means (11); said rod (16) loosely mounted with said check (22) through an aperture (26) housed within a structure (34) comprising opposed friction points (28A) and (28B) to compressively engage the extended rod (16B); said check (22) further providing a trigger (38) to lever said check (22), comprising
a magnetic means (72) adapted to said check (22) and said device (10);
whereby said magnet (72) optionally positions said check (22) onto said extended rod (16B) to engage (22B) and disengage (22A) compliant to said object (62).

2. A method for causing a compressive friction check mechanism (22) to engage (22B) and disengage (22A), utilized to hold the linear biasing forces (11A) and (11B) of a reciprocating device (10) and any object (62) attached thereto, exemplified as a door closer (10) comprising at least one rod (16) which linearly reciprocates from within a body (12) housing a biasing means (11); said rod (16) loosely mounted with said check (22) through an aperture (26) housed within a structure (34) comprising opposed friction points (28A) and (28B) to compressively engage the extended rod (16B), said check (22) further providing a trigger (38) to lever said check (22), said method
adapting a magnetic means (72) to said check (22) and said device (10);
whereby said magnet (72) optionally positions said check (22) onto said extended rod (16B) to engage (22B) and disengage (22A) compliant to said object (62).

3. A cup (72) for causing a compressive friction check mechanism (22) to disengage (22A) and engage (22B) the tensile of a rod (16) which maintains certain biasing forces (11A) and (11B) supporting any object (62) attached thereto; said rod (16) loosely mounted with the said check (22) through an aperture (26) housed within a structure (34) comprising opposed friction points (28A) and (28B) adapted to said rod (16); said check (22) further providing a trigger (38) to lever said check (22), comprising
a magnetic means (72) adapted to said check (22);
whereby said magnet (72) positions said check (22) to compressively engage (22A) and disengage (22B), for withstanding said forces (11A) and (11B) by utilizing the tinsel strength of said rod (16) compliant to said object (62).

4. A method for causing a compressive friction check mechanism (22) to disengage (22A) and engage (22B) the tensile of a rod (16) which maintains certain biasing forces (11A) and (11B) supporting any object (62) attached thereto; said rod (16) loosely mounted with said check (22) through an aperture (26) housed within a structure (34) comprising opposed friction points (28A) and (28B) adapted to said rod (16); said check (22) further providing a trigger (38) to lever said check (22), said method
adapting a magnetic means (72) to said check (22);
whereby said magnet (72) positions said check (22) to compressively engage (22A) and disengage (22B), for withstanding said forces (II A) and (II B) by utilizing the tinsel strength of said rod (16) compliant to said object (62).
